(19) United States
(12) Patent Application Publication
(10) Pub. No.: US 2005/0233036 A1
(43) Pub. Date: Oct. 20, 2005

(54) Rigid reclosable bacon package

(75) Inventors: Daniel R. Feldmeier, Waunakee, WI (US); Jay A. Edwards, Madison, WI (US); Kai O. Thompson, Waunakee, WI (US); John C. Schuette, Madison, WI (US); Bonita M. Hinze, Sun Prairie, WI (US)

Correspondence Address: KRAFT / FETF, 120 S. LASALLE STREET, SUITE 1600, CHICAGO, IL, 60603-3406, US

(73) Assignee: Kraft Foods Holdings, Inc., Northfield, IL (US)

(21) Appl. No.: 10/823,795

(22) Filed: Apr. 14, 2004

(51) Int. Cl. A23B 4/00

(52) U.S. Cl. 426/121

(57) ABSTRACT

A reclosable package is provided for packaging and displaying a shingled stack of sliced bacon or other foodstuff in a highly visible manner, including a generally rigid tray member for receiving the bacon and a generally rigid cover member, at least one of which is transparent.

### FIELD OF THE INVENTION

The present invention relates to packaged bacon products, more particularly to reclosable packages for shingled bacon slices.

### BACKGROUND OF THE INVENTION

Bacon has long been available to retail consumers in sliced form, often within sealed packages containing sliced bacon in a shingled array. These bacon packages are often vacuum-sealed. Typically, a provision is made for viewing a portion of some of the shingled bacon slices.

A prior bacon package of this type is shown in Seiferth et al. U.S. Pat. No. 3,803,332. A stack of bacon slices is arranged in a shingled relation on a backing board, which usually is non-transparent, and the bacon slices are enclosed between transparent top and bottom flexible plastic wrapper sheets having their marginal portions sealed to each other about the periphery of the backing board. The space between the wrapper sheets typically is vacuumized. For merchandising, the wrapped bacon typically is placed inside a paperboard carton having a cut-out window for viewing the plastic wrapped bacon.

In such prior bacon packaging arrangements, much of the surface area of the packaged bacon slices is not visible to store customers. In making their purchasing decisions, many consumers would like to be able to visually inspect more of the bacon slices through the packaging, e.g., to obtain an indication of their relative lean and fat contents.

Another concern is that the flexible plastic wrapper bacon packages make it difficult to avoid contact between a consumer's fingers and oily inner packaging surfaces when the consumer is removing a bacon slice or slices from inside the package. Usually, in order to gain access to a bacon slice, the consumer must open and hold open a package panel or otherwise touch a part of an inner package surface that has a fatty oil film resulting from previous contact with the enclosed bacon. This contact with a fatty oil film on an inner package surface may occur when a consumer initially opens the package, when accessing a previously opened package, and/or when holding open a package during removal of a bacon slice or slices from the package. Customers may want to minimize their direct hand contact with oily surfaces.

Prior bacon packages of the type described above are difficult to reseal, once opened, as they do not have positive means by which the package can be reclosed in order to sealingly contain the remaining bacon strips within the package once it has been opened.

There is a need for reclosable bacon packages that provide enhanced product visibility and reduce or eliminate consumer hand contact with oily package surfaces.

### SUMMARY OF THE INVENTION

The invention provides a reclosable package for displaying a shingled stack of sliced bacon in a highly visible manner, including a generally rigid tray member for receiving the bacon and a generally rigid cover member that are reclosably sealed together.

In one embodiment, a reclosable bacon package includes a tray member having a tray base, generally upstanding tray sidewalls, and generally upstanding tray endwalls, and a tray member peripheral flange which surrounds an open mouth located generally opposite the tray base. The tray base comprises a generally flat central base portion disposed between two inclined base portions which merge with the generally upstanding tray sidewalls at respective locations below the tray member peripheral flange. In this manner a lower recess is provided within the tray member to receive a stack of shingled bacon while leaving head space above the bacon. A peripheral ledge portion extends along the inner (food side) surface of the sidewalls and endwalls adjacent the mouth of the tray member.

A cover member is inserted partly within the mouth of the tray member and above the bacon to reduce air space within the packaged enclosure, and is releasably securable onto the tray member. The cover member includes a cover panel, a cover member peripheral flange, and a peripheral inset portion joining and spacing the cover panel and the cover member peripheral flange. The cover panel and peripheral inset portion of the cover member are slidably insertable a limited distance within the tray member along the peripheral ledge portion thereof until the peripheral flange of the cover member seats on the peripheral flange of the tray member. When the cover member is seated on the tray member, an interior volume is defined having a volume and a shape suitable for enclosing a stack of shingled bacon supported on the tray base. The multi-contoured tray base conforms well to the shape of a shingled stack of bacon to support and permit the stack of shingled bacon to be displayed through the cover member panel in a highly visible manner.

To provide for convenient and reliable reclosure of the package, the peripheral inset portion of the cover member includes projections that are releasably engageable in a snap-fitting manner with respective indentations on the tray member peripheral ledge, or vice versa, such that the cover member and the tray member may be releasably locked together, even after an original package seal is broken.

As will be appreciated, the invention provides reclosable packages for shingled bacon slices or other bacon products which are displayable with high product visibility, and which may be repeatedly opened, securely reclosed, and handled without a consumer's fingers needing to contact inner surfaces of the package that may have fat residue thereon. These advantages, among others, may help to increase consumer interest in and satisfaction with the packaged product.

The invention also provides a method for packing shingled bacon slices, using the reclosable container. In one embodiment, the method steps may include providing a reclosable package as described herein, introducing shingled bacon slices into the rigid tray member, optionally flushing the container with inert gas, and, covering the rigid tray member with a cover member having a cover member peripheral inset portion that includes a plurality of projections or indentations releasably engageable with indentations or projections on a tray member peripheral ledge for releasably closing together the cover member and the tray member.

### BRIEF DESCRIPTION OF THE DRAWINGS

In the course of this description, reference is made to the attached drawings, wherein:

FIG. 1 is perspective view of a reclosable bacon package in accordance with one embodiment of the present invention.

FIG. 2 is a cross-sectional view along the section 2-2 of FIG. 1.

FIG. 3 is a cross-sectional view along the section 3-3 of FIG. 1.

FIG. 4 is an enlarged partial sectional exploded view of the cover member of the bacon package of FIG. 1.

FIG. 5 is a bottom plan view of the cover member.

FIG. 6 is a perspective view of the tray member of the bacon package of FIG. 1.

FIG. 7 is a bottom view of the tray member of FIG. 6.

FIG. 8 is a top view of the tray member of FIG. 6.

FIG. 9 is a cross-sectional view taken along section A-A of tray member of FIG. 8, as situated on a mold used for making same.

FIG. 10 a top view of a portion of the package flange area showing an optional easy-access opening feature of the bacon package of FIG. 1.

FIG. 11 is a perspective view of a sealed reclosable bacon package in accordance with another embodiment of the present invention.

FIG. 12 is an enlarged cross-sectional view of lidstock and tray stock film laminates useful for constructing a bacon package in accordance with FIG. 1 or FIG. 11.

FIG. 13 is a flow chart of a method for manufacturing the sealed reclosable bacon package of FIG. 1 or FIG. 11.

The figures and features depicted therein are not necessarily drawn to scale. It also will be appreciated that use of relative spatial descriptions herein such as upper, lower, above, beneath, and the like, are used merely for convenience to simplify the illustration under discussion, and are not necessarily limiting. Similarly numbered elements in different figures represent like features unless indicated otherwise.

### DETAILED DESCRIPTION OF THE PREFERRED EMBODIMENTS

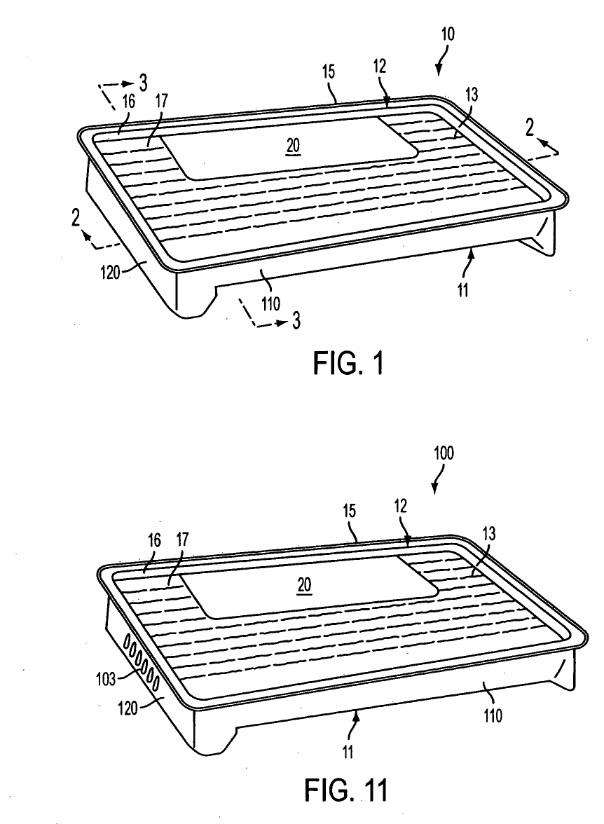

Referring to FIG. 1, a shaped, generally rigid synthetic plastic package 10 for storing and displaying a shingled stack of bacon slices 13 in accordance with an embodiment of the present invention is shown, which includes a tray member 11 and a cover or lid member 12. Both tray member 11 and cover member 12 are of film construction in which the film is semi-rigid or rigid and has been shaped or is shaped in-line, such as by suitable forming or heat molding techniques, into the shapes illustrated in the drawings. The terms “rigid” and “semi-rigid” are used herein to indicate that the structures made of these films have the ability to retain their respective shapes during normal handling. The tray member 11 has a pair of opposite longitudinal sidewalls including sidewall 110, and a pair of opposite endwalls including endwall 120. Thus, the tray member 11 and cover member 12 may provide a protective display package for a shingled stack of bacon slices. The shingled stack of bacon slices 13 is sealed within package 10, which bacon slices may be uncooked, partially cooked or fully cooked. The term “bacon,” as used herein may refer to meat-containing or meatless bacon.

At least one of the cover member 12 and tray member 11 is preferably transparent to the extent that portions of bacon supported within the package 10 can be readily viewed and inspected by a consumer prior to purchase. In the embodiment illustrated in FIGS. 1-10, both the tray member 11 and the cover member 12 are illustrated as being transparent. In other embodiments, they may be partially or entirely opaque. Preferably, at least the cover member is transparent.

One or more label(s) 20 may be included in order to satisfy marketing and regulatory labeling needs and requirements. The labels may comprise opaque backings including legible print thereon. Alternatively, one or more of such labels may be partially transparent or maybe partially or entirely translucent. In one embodiment, pressure sensitive labels are used, which may be affixed to an exterior side of the cover member, tray member, or both. Alternatively, the labels may be affixed to an interior (food side) surface of transparent package components. In another alternative, print is affixed directly on a layer of a film comprising a package component.

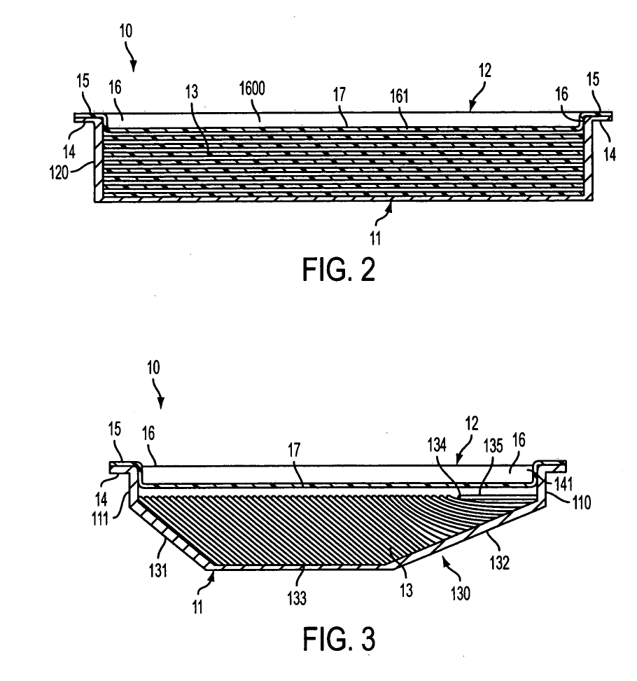

As shown in FIG. 2, cover panel 17 of the cover member 12 is inset. A peripheral flange 15 of the cover member 12 is spaced away from the cover panel 17 by a peripheral inset portion 16. Cover member flange 15 rests in contact on tray member flange 14. In this manner, the cover panel 17 projects into the tray member 11 when the package 10 is in its closed condition. A well 1600 is defined within the upper surface (non-food side) 161 of cover member 12 with cover panel 17 at its bottom and peripheral inset portion 16 defining its lateral sides.

As shown in FIG. 3, the base 130 of the tray member 11 comprises a generally flat central base portion 133 disposed between two inclined base portions 131 and 132 which merge with the opposite tray sidewalls 110 and 111, respectively, at respective locations below the tray member peripheral flange 14. The shingled bacon 13 is stacked on the base 130 such that a slice of bacon 134 at one end of the package is reposed in a substantially horizontal position such that the upper face 135 thereof is readily visible.

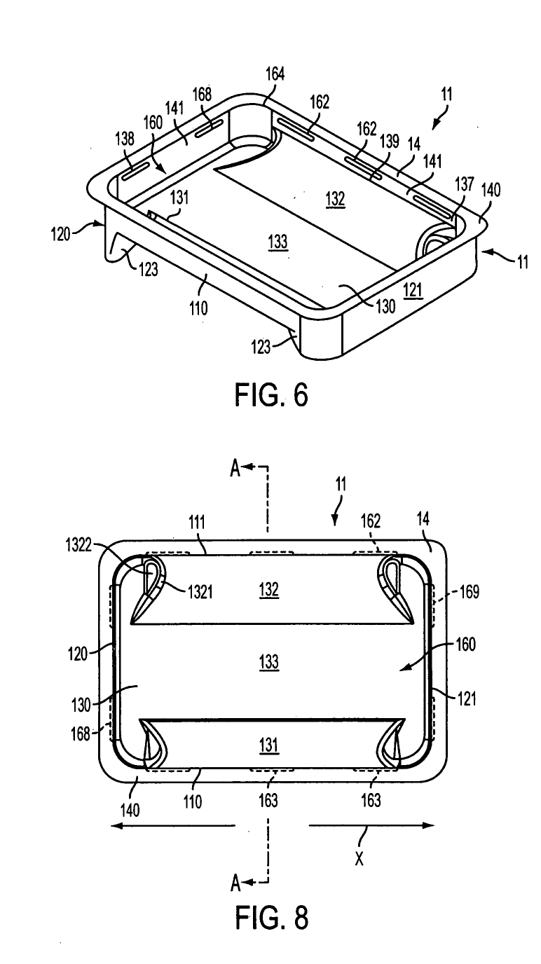

In one embodiment, a sliding friction fit is made between peripheral inset portion 16 of the cover member 12 and an inner peripheral ledge portion 141 of the tray member 11 which provides a positive acting reclosure feature by which the consumer has an audible acknowledgement and or tactile experience of closure completion by having a tight fitting arrangement. The peripheral ledge portion 141 also is shown in FIG. 6, which is discussed in more detail below.

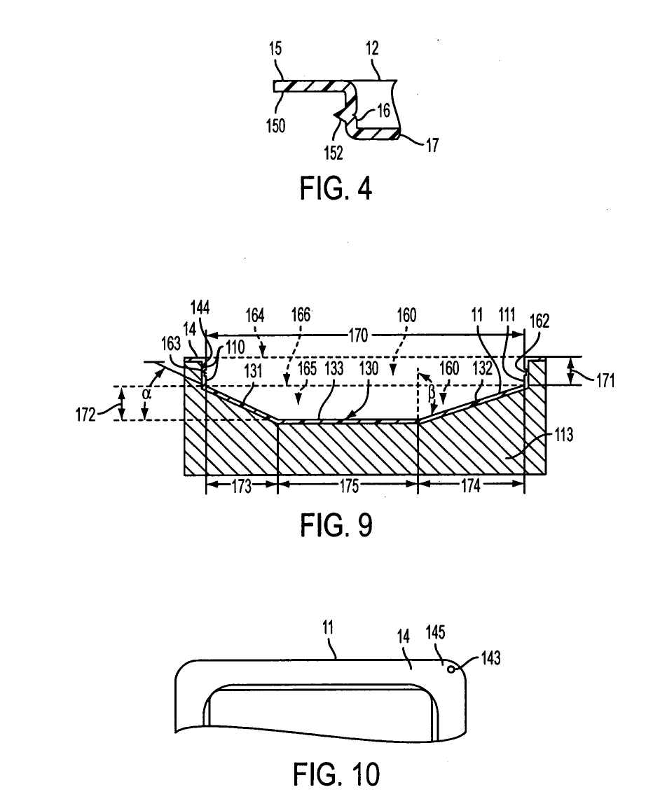

Referring to FIG. 4, in this embodiment, this closure feature comprises a projection 152, such as a rib or other protuberance, along peripheral inset portion 16 of the cover member 12. The bottom surface 150 of the flange 15 is indicated in this view. The projection 152 of the peripheral inset portion 16 of the cover member 12 is received within a corresponding indentation, such as a groove, formed along the peripheral ledge portion 141 of the tray member, as will be discussed in more detail hereinafter.

In a preferred embodiment, a plurality of such projections are provided along peripheral inset portion 16 at least at one set of opposite outer sides of the peripheral inset portion 16 of the cover member 12, which can engage a plurality of corresponding indentations provided along the peripheral ledge portion 141 of the tray member at opposite inner sides of the tray member.

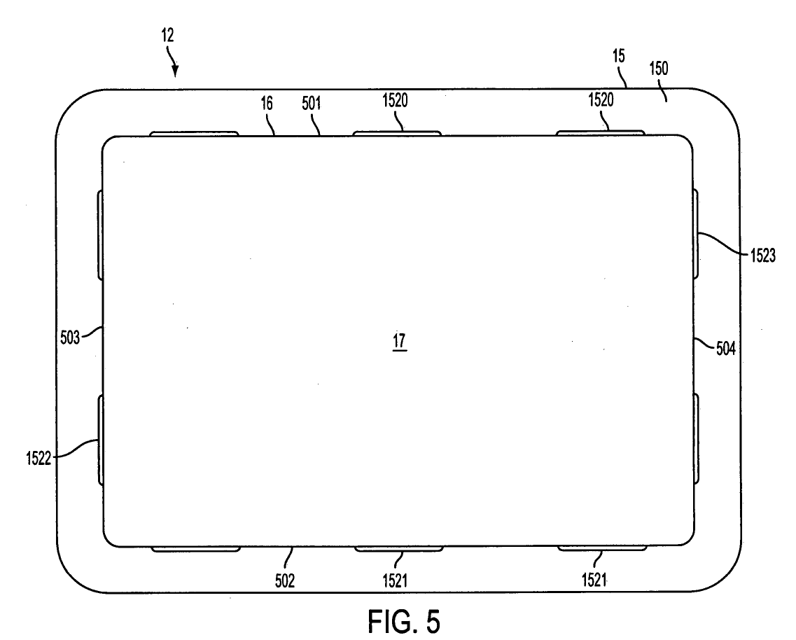

Referring to FIG. 5 in this respect, a transparent cover member 12 is shown with the above-noted bottom surface 150 of peripheral flange 15, cover panel 17, and the peripheral inset portion 16. In this illustration, a plurality of projections 1520 and 1521, which may be similar to above-described projection 152, are integrally formed on opposite sides 501 and 502 of the peripheral inset portion 16, and a plurality of projections 1522 and 1523, also which may be similar to above-described projection 152, are integrally formed on the other set of opposite sides 503 and 504 of the peripheral inset portion 16. Alternatively, projections may be provided on only one set of the opposite sides of inset portion 16, but not on both sets of opposite sides. In another option, projections are provided at the corners of inset portion 16 (not shown). The purpose and function of these projections will become more apparent in the following discussion of the container tray member.

Referring to FIG. 6, tray member 11 as shown includes longitudinal sidewall 111 which merges or intersects with tray base portion 132 at a location 139 below flange 14, and opposite longitudinal sidewall 110 similarly merges with base portion 131. A plurality of grooves 162 are provided along the peripheral ledge portion 141 along the longitudinal sidewall 111 of the tray member 11, and at the opposite longitudinal sidewall 110 of the tray member (which are hidden in this view). These grooves are adapted to receive corresponding ribs 1520 and 1521 provided along the peripheral inset portion 16 of the cover member 12 (see FIG. 5).

As shown in FIG. 6, a plurality of grooves 168 are also provided along the peripheral ledge portion 141 where it extends along the endwall 120 of the tray member 11, and at the opposite endwall 121 of the tray member (which are hidden in this view). These grooves are adapted to receive corresponding ribs 1522 and 1523 provided on the peripheral inset portion 16 of the cover member 12 (see FIG. 5).

Grooves 162, 168, and those provided on the opposite walls thereto, are integrally located on the inner (food side) surface 137 of the sidewalls and endwalls of the tray member 11 at locations below and relatively close to the tray's mouth 164 which is located at the flange surface level 140 of the tray member 11. In this illustration, the grooves 162 and 168 are located very close to the mouth 164 with only a narrow intervening ungrooved section 138 of endwall or sidewall separating them. In this illustration, the ribs and grooves extend generally sideways (i.e., laterally) relative to the container parts. Alternatively, grooves may be provided in opposing sidewalls or opposing endwalls, but not in both sets of walls. In another option, grooves are provided in tray member corners (not shown).

To releasably attach the cover member 12 to the tray member 11, the cover panel 17 may be inserted a distance downward within the cavity 160 of tray member 11 until its flange 15 comes to rest on tray flange 14, and the ribs 1520 are releasably lodged within grooves 162, and similarly with respect to the other cover member rib and tray member groove combinations such as described herein. This releasable closure and reclosure of the tray and cover members can be conveniently done by manual manipulation of the cover member and tray member by a user.

A plurality of such corresponding ribs and grooves may be provided along the inset portion 16 of the cover member 12 and along the peripheral ledge portion 141 of the tray member 11 in segmented form, or, alternatively, the respective ribs and grooves may be formed as continuous features that encircle or substantially encircle the entire peripheral inset portion 16 of the cover member and below peripheral ledge portion 141 of the tray member. In one embodiment, the grooves 162, 168, and so forth, are formed as segments in tray member 11 which extend generally horizontally at substantially the same vertical distance from the base 130 of the tray member 11.

It also will be appreciated that the placement of these snap-fitting engagement structures may be reversed such that the peripheral inset portion of the cover member has indentations which releasably snap into projections provided on the peripheral ledge portion of the tray member. Also, the number and location of the various interlocking grooves and ribs shown in this illustration is exemplary, and is not intended to be limiting.

Referring still to FIG. 6, a plurality of protuberances or “feet” 123 may be molded into the bottom side of the tray member 11. Multiple containers as described herein may be more conveniently and easily stacked by forming the feet 123 on tray 11 of container 10 at positions which may be conformably nested from above within a well 1600, such as indicated above (e.g., FIG. 2), which is molded into the cover member 12 of an underlying separate container having a similar construction, effective to restrict lateral movement of the feet 123 of the overlying tray member.

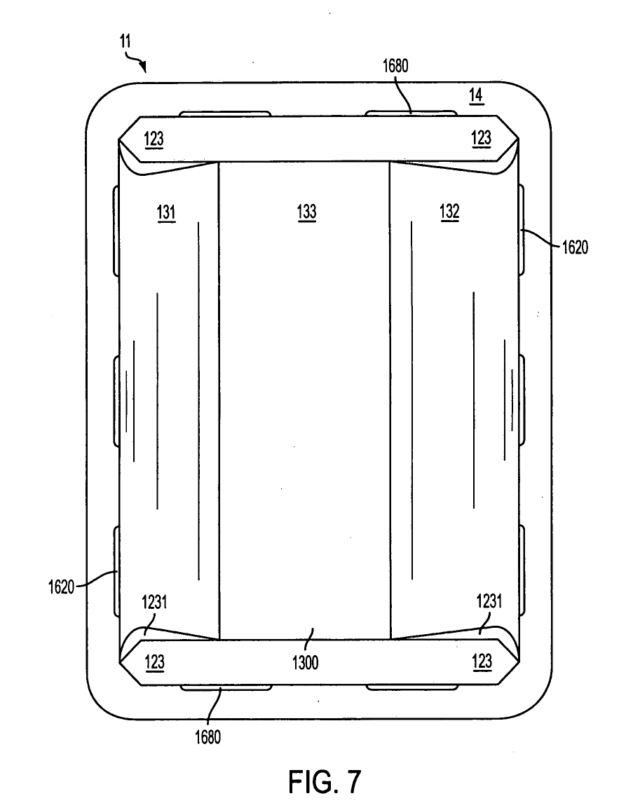

Referring to FIG. 7, feet 123 on a tray member 11 are shown in further detail. The feet arrangement shown is merely illustrative and not limiting. The central base portion 133, inclined base portions 131 and 132, and tray member flange 14 of tray member 11 are also indicated, as well as molded indentations 1620 and 1680 which define above-noted grooves 162 and 168. In this illustration the feet 123 have slightly sloping sides 1231 that merge with underside (non-food side) 1300 of the tray base 130, although such sloping sides are not required. The feet 123 generally are upraised a distance from inclined base portions 131 and 132 which is at least approximately level with flat central base portion 133, and may optionally extend beyond base portion 133 a distance that can be accommodated by the depth of a well (1600) of an underlying cover member of another container to which it makes contact in a container stacking arrangement (not shown). In an alternative embodiment, the feet may be omitted, and, for example, the bottom side of the tray member 11 may have the profile such as shown by FIG. 3 at the end walls 120 and 121 as well as the intervening bottom side portions comprising base portion 133 and inclined base portions 131 and 132.

Referring to FIG. 8, the tray member 11 is illustrated having the pair of sidewalls 110 and 111, the pair of endwalls 120 and 121, and the base 130, which together define a cavity 160 into which a stack of shingled bacon may be disposed and supported. As illustrated, the tray sidewalls, endwalls, and base are unified within a common integral tray structure, such as a molded or thermoformed plastic structure. The tray member's peripheral flange 14 extends along upper exposed ends of the sidewalls 110, 111 and endwalls 120, 121 to provide a generally flat rim-like sealing and closure surface 140 for attachment of the cover member 12 via its flange 15 to enclose the shingled bacon within the cavity 160.

As shown in FIG. 8, grooves 162 (indicated in phantom lines) in sidewall 111 and grooves 163 (indicated in phantom lines) in opposite sidewall 110 are formed in the peripheral ledge portion 141, and grooves 168 (indicated in phantom lines) in endwall 120 and grooves 169 (indicated in phantom lines) in opposite endwall 121 are also formed in the peripheral ledge portion 141. These sets of grooves can be releasably engaged with corresponding ribs formed around the peripheral inset portion 16 of cover member 12.

As also illustrated in FIG. 8, the base 130 of the tray member 11 is shown with inclined base portions 131 and 132 having lengthwise dimensions which extend generally parallel to direction “X”, and which extend across most of the space between the endwalls 120 and 121 of the tray member. Preferably, inclined base portions 131 and 132 extend a lengthwise distance sufficient to minimize sagging of any parts of the stack of shingled bacon off inclined base portions 131 or 132. The inclined portions are shown as continuous surfaces. Alternatively, they may also be implemented as intermittent upraised portions (not shown) which are sufficient to support one or the other ends of a stack of bacon slices without significant product sagging. The lengthwise direction of individual slices of bacon within a common stack placed in tray member 11 run in a direction generally parallel to the “X” direction indicated in FIG. 8. The lengthwise dimension of tray base 130 in direction “X” preferably will accommodate the bacon slice length.

FIG. 8 also shows inclined base portion 132 with gently downward sloping sidewalls 1321 which have a rounded portion 1322 near sidewall 111. It will be appreciated that the inclined base portion alternatively could have a non-sloping triangular-shaped sidewall oriented at approximately a right angle to the base 130, or other suitable geometry. Base portion 131 generally has similar sidewall arrangements.

Referring to FIG. 9, tray member 11 is shown in a thermoformed configuration while still situated on a mold 113 used to impart the desired shape, such as by using techniques described in more detail subsequently herein. The tray member 11 is sufficiently rigid to retain the imparted molded shape after its removal from the mold 113. The base 130 of the tray member 11 comprises a generally flat central base portion 133 disposed between two inclined base portions 131 and 132 which merge with the generally upstanding tray sidewalls 110 and 111, respectively, at respective locations below the tray member peripheral flange 14. The open mouth 164 of the tray member opposite base 130 has a dimension 170 sufficient to conformably receive a stack of shingled bacon. The dimension 170 extends generally perpendicular to the lengthwise direction of bacon slices placed as a stack within tray member 11. In this illustration, inset regions may be molded into the bottom side of the tray member.

As illustrated in FIG. 9, inclined base portion 131 is designed with width 173 and inclination angle alpha (α). Inclined base portion 132 is designed with width 174 and an inclination angle of (90-beta (β)). Generally flat central base portion 133 has a width 175. In one non-limiting embodiment, angles alpha (α) and (90-beta (β)) individually may range from about 20 to about 40 degrees. The inclination angle of the base portion that will be situated below a generally flat (horizontally-oriented) bacon slice of high surface area visibility, such as base portion 132 in FIG. 3, preferably has a relatively smaller, e.g., about 3 to about 10 degrees smaller, inclination angle than that of the other base portion to impart a flatter orientation of the bacon slices at that end. The inclined base portions 131 and 132 individually may have widths of about 50 to about 80% the width of the central base portion. In one embodiment, the relative width dimensions 173/175/174 of the base portions 131/133/132 are about 0.5-0.6/1.0/0.7-0.8, respectively.

As may be better appreciated by reference again to FIG. 3, the multi-contoured tray base 130 is configured with inclination angles and with widths such that a stack of shingled bacon 13 may be conformably inserted upon base 130, whereby the stack of bacon slices may be stacked up a gradually declining angle relative to cover panel 17 from back-to-front (i.e., from base portion 131 to base portion 132) within the package. Consequently, as noted, at least one bacon slice 134 lies substantially flat above base portion 132 so that a potential purchaser may readily view one of its surface faces 135, and not merely an edge portion thereof. This permits a potential purchaser to more readily observe the relative amount of lean portion and fat portion of a representative bacon slice.

Referring again to FIG. 9, lower recessed portion 165 is the space defined between plane 166 and the multi-contoured base 130. Recessed portion 165 has a depth 172 sufficient to accommodate most of the expected thickness of a stack of shingled bacon, when supported on base 130. In one embodiment, not all the bacon stack fits within recessed portion 165, but all the bacon does generally fit within the closed container 10 when the cover member 12 is attached to the tray member 11. Also, plane 166 is shown as oriented generally parallel to base portion 133, although it will be appreciated that a parallel relationship is not required as long as recessed portion 165 is sized sufficiently to receive a stack of bacon. Distance 171 generally corresponds to the vertical height dimension of the longitudinal sidewalls 110 and 111, which is less the vertical height (the sum of distances 171 and 172) of the endwalls 120 and 121. The distance 171 is at least equal in magnitude to the separation distance that the peripheral inset portion 16 of cover member 12 creates between the cover flange 15 and cover panel 17. The cover panel and peripheral inset portion of the cover member thus are conformably insertable within the tray member until the peripheral flange 15 of the cover member seats on the peripheral flange 14 of the tray member, and a plurality of ribs (1520, 1521, 1522, 1523) on cover member peripheral inset portion 16 are manually snapped into the sets of grooves (162, 163, 168, 169) at the upper peripheral ledge 141 of tray member 11.

Therefore, when tray member 11 supports a stack of shingled bacon on base 130, a cover member 12 may be snap-fitted into place upon the tray member. These tray features permit a stack of shingled bacon to be supported in position within tray member 11 and displayed through the packaging in a highly visible, orderly manner. In one embodiment, the cover member 12 is structured such that its panel member 17 touches the bacon and applies force thereto to aid in maintaining the bacon shingle through the bacon distribution/purchase cycle.

With this arrangement in accordance with the present invention, more bacon slice surface area is visible to the consumer prior to purchasing and opening the package of bacon. The reclosable package helps keep product fresh after opening. The combination of rigid plastic tray member and rigid plastic lid, as described herein, allows reclosure of the package after the consumer opens the hermetic seal of a gas-flushed package. The generally rigid constructions of both the tray and cover members, together with the provision of the above-noted closure features at the flanges of the components, also may permit a consumer to open and reopen the package with minimized hand contact occurring or needed with interior surfaces that may be coated with fat residue.

In another embodiment, the bacon slices are easier to separate because the package is gas flushed and the rigidity helps prevent the bacon from being pushed together. The form of the tray member also holds the slices in a shingle arrangement and still lays the last slice flat to allow easy access and removal. If desired this slice may be made visible by moving the face label and the tray member material may be made of less expensive non-transparent material. In one non-limiting embodiment, the cover member comprises transparent plastic, and any labeling placed on the transparent cover member is positioned such that at least about 70% or more of at least one bacon slice contained in the package remains viewable through the cover member.

In one embodiment, a structural feature is included as an integral part of the flange of either the tray member or the cover member components as a means to facilitate initiation of manual peeling of the components apart at their sealed flanges. Referring to FIG. 10, one optional mechanism used to facilitate manual opening of the sealed or closed container may be small upraised projection or bump 143 provided in a corner 145 of flange 14 of tray member 11, which feature makes it easier to start peeling the sealed flanges apart using digital manipulation.

A generally known easy-open mechanism that optionally may be used is a lateral cut-out formed in the cover member flange that laterally extends inward relative to the outer perimeter of the adjoining tray flange (not shown), which provides an easier site from which to initiate manual peeling of the components apart.

The tray member may be transparent plastic, semi-transparent plastic, or opaque plastic. If the tray member is not transparent plastic, then the cover member must be transparent plastic and any labeling placed on the cover member preferably should permit at least about 70% or more of at least one bacon slice to be viewable from that perspective.

FIG. 11 shows an alternative embodiment of the present invention in which a reclosable bacon package 100 has features similar to those described herein relative to FIGS. 1-10, except that a colored or opaque (i.e., non-transparent) tray member 11 is used in combination with transparent cover member 12. Although not required, a plurality of vertically-oriented wall ribs 103 may be integrally molded into the tray member endwalls (and or sidewalls) for additional structural reinforcement in embodiments of the present invention.

In these non-limiting illustrations, the tray member has a generally rectangular-shaped profile (from a top view perspective). Other package profiles may be used, depending on the dimensions of the shingled stack of bacon slices and to the extent a profile accommodates the multi-contoured tray base used in accordance with this invention to help display the package contents. For example, if the shingled stack of bacon strips has a size similar to that of the lengths of the individual bacon strips, then a more squared-shaped profile may be suitable for the tray member. The profile of the cover member usually generally corresponds to that of the tray member.

The cover member and tray member independently can be made from a variety of materials including homogenous plastic films, plastic films provided with heat sealable coatings, multi-layered film laminates, and/or co-extruded films, and the like. In one embodiment, packaging material useful for the cover member and tray member generally is a multi-layered plastic film construction suitable for packaging of refrigerated meat products including at least (a) a thin, intermediate layer which is substantially impervious to oxygen, in combination with (b) an outer structural layer having sufficient structural characteristics so that the laminate is sufficiently rigid for shape retention during handling, and usage of integral snap-fit closure features included with the package, and (c) a sealant layer suitable for heat sealing procedures.

In one embodiment convenient for larger scale production, the tray member and cover member separately may be manufactured as respective thermoformable multi-layered webs, which may be supplied as roll stock and run on a form-fill-seal machine, or the like. In one preferred embodiment, the cover member and tray member container components are each made with a respective multi-layer film construction.

In one particular embodiment, the cover member 12 is a transparent multi-layer film construction, and the tray member 11 is a transparent or colored multi-layer film construction.

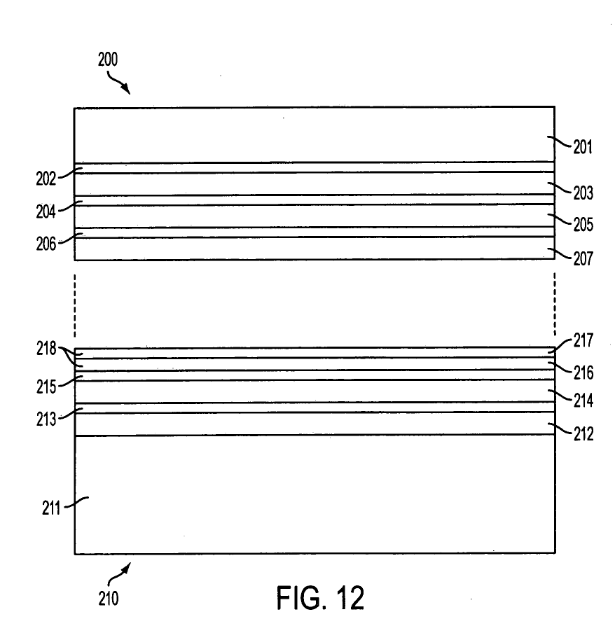

Referring to FIG. 12, in one non-limiting example, a scheme of layers of the transparent multi-layer film 200 useful to construct a cover member is: outer structural layer 201/primer 202/ethyl vinyl acetate copolymer (EVA) layer 203/tie resin 204/ethylene vinyl alcohol (EVOH) copolymer barrier layer 205/tie resin 206/sealant layer(s) 207. In one embodiment, the cover member multi-layer film generally may have a thickness of about 5 to about 20 mils, and particularly about 8 to about 12 mils.

In the construction of a transparent cover member, the outer (i.e., opposite to the food side) structural layer 201 of the multi-layer film used to construct the cover member may be a relatively rigid plastic material that will substantially retain a shape that will be thermoformed therein. Non-limiting examples of the outer structural layer include amorphous polyester (e.g., amorphous polyethylene terephthalate), polypropylene, polystyrene, polyester copolymers such as polyethylene terephthalate glycol (e.g., Vivak®), styrene-butadiene copolymers (e.g., K-resin®), or acrylonitrile (e.g., Barex®). The outer structural layer 201 may have a thickness of about 6 to about 12 mils. In transparent container components, these plastics will be clear and non-colored.

Enhanced oxygen barrier properties generally are imparted in the multi-layer film used to construct the cover member by providing an intermediate barrier layer 205. For example, the intermediate barrier layer may be an ethylene vinyl alcohol copolymer (EVOH) layer, or a coating of polyvinylidene chloride (e.g., Saran®, from Dow Chemical). The EVOH layer may be combined with an intermediate ethyl vinyl acetate (EVA) layer 203 via a tie resin 204 towards the outside (non-food side) of the multi-layer film 200, and the EVA layer in turn is attached to the outer structural layer. The EVA layer may be primed with an adhesive or solvent primer 202 suitable to assist its attachment to the outer structural layer 201, or, alternatively they may be thermally laminated, co-extruded, or the like.

The tie resin may be generally known compositions used for attaching two layers in multi-layer packaging films. Such tie layers are internal film layers which those of skill in the art recognize as being compatible with other compositions, i.e., suitable for direct adhesion to other types of plastic layers commonly used in packaging films. Tie layers may include polymers having grafted polar groups so that the polymer is capable of covalently bonding to polar polymers. Useful polymers for tie layers include ethylene/unsaturated acid copolymer, ethylene/unsaturated ester copolymer, anhydride-modified polyolefin, polyurethane, and mixtures thereof. One particular non-limiting example of polymers for tie layers include one or more of ethylene/vinyl acetate copolymer having a vinyl acetate content of at least 15 wt. %, ethylene/methylacrylate copolymer having a methyl acrylate content of at least about 20 wt. %, anhydride-modified ethylene/methyl acrylate copolymer having a methyl acrylate content of at least 20 wt. %, and anhydride-modified ethylene/alpha-olefin copolymer, such as an anhydride grafted LLDPE. The tie layers are of sufficient thickness to provide the adherent function, as is known in the art. Each tie layer may be of a substantially similar or a different composition and/or thickness.

A sealant layer 207 is provided on the opposite, food side of the multi-layer film used to construct the cover member relative to the outer structural layer. The sealant layer may be joined to the intermediate EVOH barrier via a tie resin. The sealant layer is used in heat-sealing the cover member to the tray member after the tray member is filled with bacon or other foodstuff.

Heat sealable materials usually are thermoplastic film-forming polymers, and are well known in the art. The heat sealable materials must be compatible with the layer to which it is going to be sealed or heat-sealed. They may desirably include ethylene polymers and copolymers, and copolymers of ethylene and an ethylenically unsaturated comonomer selected from the group of carboxylic acids and esters, salts and anhydrides thereof. Examples of suitable sealant polymers include, for example, ionomers, and sealant materials selected from ethylene vinyl acetate (EVA), ethylene methyl acrylate (EMA), low density polyethylene, linear low density polyethylene, and blends of HDPE with EVA or with EMA, and the like. Ionomers are advantageous in the sealing layer of a film or web because they melt at relatively low temperature, produce a relatively strong heat seal, and may be used for rupturable sealant layers. Ionomers generally are metal-neutralized copolymers of an olefin and a carboxylic acid. More particularly, they may be metal salts of ethylene-acrylic or methacrylic acid copolymers having pendant carboxylate groups associated with monovalent or divalent cations such as sodium or zinc. Commercially-obtained ionomers that are suitable for packaging film applications include, for example, Surlyn® from E.I. du Pont de Nemours and Co.

In one preferred embodiment, the sealant layer is a sodium or zinc ionomer layer which contains or is coated with an anti-fog agent. The anti-fog agent helps keep the layer clear of condensed water droplets. Suitable anti-fog agents are generally known and may fall into classes such as esters of aliphatic alcohols, esters of polyglycol, polyethers, polyhydric alcohols, esters of polyhydric aliphatic alcohols, polyethoxylated aromatic alcohols, nonionic ethoxylates, and hydrophilic fatty acid esters.

The sealant film material may be a continuous layer, or alternatively only applied around the periphery of the multi-layer construction where it will correspond at least to the flange portion of the package part that will be molded or thermoformed with the multi-layer film. Generally, the sealant layers may have a thickness between about 0.1 mils to about 0.5 mils, although other thicknesses are not excluded. In one embodiment, the combination of the EVA/tie/EVOH/tie/ionomeric sealant layer(s) of the multi-layer film (i.e., the stack of layers not including the outer structural layer) used for cover member constructions may have a total thickness of about 1.25 to about 4 mils.

Optionally, one or more of the barrier and sealant layers, or at least a portion of the entire sealant and/or barrier layers may be cross-linked to improve the strength of the film, improve orientation of the film, and help to avoid burn-through during heat seal procedures. Cross-linking may be achieved by using chemical additives or subjecting one or more film layers to one or more energetic radiation treatments, e.g., ultraviolet radiation or electronic beam treatment, to induce cross-linking. Useful radiation dosages for this purpose are generally known in the art.

Also optionally, all or a portion of one or two surfaces of the sealant and/or barrier layers optionally may be corona and/or plasma treated by methods known in the art to change the surface energy of the film, for example, to increase the ability to print or laminate the film.

The outer structural layer, EVA, barrier, and sealant films may each be separately manufactured by thermoplastic film-forming processes generally known in the art, such as extrusion or casting. The non-amorphous films may be machine-direction oriented, transverse-direction oriented, or, preferably, biaxially oriented. The multi-layer films may be consolidated together as an adhesively laminated web.

Referring still to FIG. 12, the package tray member may be a transparent or colored construction. In one non-limiting example, the scheme of layers of a multi-layer film 210 may be used in manufacturing a tray member, which comprises a (colored) outer structural layer 211/EVA 212/tie resin 213/EVOH barrier 214/tie resin 215/multifilm sealant layer 218 comprised of sealant sublayers 216 and 217. In one embodiment, the tray member multi-layer film generally may have a thickness of about 10 to about 25 mils, and particularly about 12 to about 18 mils.

In one embodiment, multi-layer films useful for constructing colored or transparent tray members are provided with an outer (i.e., opposite the food side) structural layer 211 useful for imparting rigidity and shape retention. If the multi-layer film will be used to construct a colored tray member, the outer structural layer may be colored, such by incorporating colorant and or pigment to impart opacity in the layer. In one embodiment, an outer structural layer 211 used to impart structural rigidity in webs for tray member constructions may comprise a high impact polystyrene (HIPS), polystyrene, polyester (e.g., colored polyester terephthalate), high density polyethylene (HDPE), polypropylene polyester copolymers such as polyethylene terephthalate glycol (e.g., Vivak®), styrene-butadiene copolymers (e.g., colored K-resin®), or acrylonitrile (e.g., Barex®).

In one preferred embodiment, a HIPS material (colored or transparent) is used for the outer structural layer of the tray member as it combines useful functionality and cost attractiveness. The outer structural layer 211 of the tray member may have a thickness of about 8 to about 24 mils. The colorant, when incorporated in the outer structural layer, may be a compatible pigment or dye that may be blended or dispersed in an amount effective to impart opacity to outer structural layer. Alternatively, an intermediate coloration layer (not shown), such as an ink layer, may be disposed between the outer structural layer and a sealant layer provided on the opposite face of the same film laminate.

For the multi-layer films used for tray member construction, enhanced oxygen barrier properties also may be imparted by providing an intermediate barrier layer 214, such as an ethylene vinyl alcohol copolymer (EVOH) layer or a coating of polyvinylidene chloride (“Saran®”, from Dow Chemical). The EVOH layer may be combined with an ethyl vinyl acetate (EVA) layer 212 via an intervening tie resin layer 213, on the side of EVOH layer nearest the outer structural layer. The EVA layer 212 is attached to the inner (food-side) of outer structural layer 211, and, again, a primer (not shown) may be used to facilitate the interfacial attachment thereof, or, alternatively they may be thermally laminated or co-extruded, and the like.

A sealant layer 218 is provided on the opposite food side of the EVOH layer of the same multi-layer film to be used in manufacturing a tray member. The sealant layer 218 may be joined to the EVOH barrier 214 via a tie resin 215. The sealant layer is used for heat-sealing the tray member to the cover member after the tray member is filled with bacon or other foodstuff. The sealant layer may comprise the above-noted materials used with respect to the cover member web. In one preferred embodiment, the sealant layer used in the tray member web comprises a sodium or zinc ionomer layer which contains an anti-fogging agent. In one embodiment, the combination of the EVA/tie resin/EVOH/tie resin/ionomeric sealant layer(s) may have a total thickness of about 1.25 to about 4 mils.

In a preferred embodiment, at least one of the sealant layer constructions 207 or 218 provided on the food side of either the multi-layer film for cover member constructions or the multi-layer film for tray member constructions comprises a rupturable multi-film sealant layer construction. In an embodiment of rupturable multi-film sealant layer construction illustrated in FIG. 12, sealant layer 218 comprises an outer (i.e., food side) sealant sublayer 217 which is attached to an adjoining inner base member sealant sublayer 216. In one embodiment the sealant sublayer 217 is comprised of a similar material and is selected from the same group of materials, and in a similar thickness, as described above relative to sealant layer 207. The various films used in package walls 210 and 200 are selected such that the base member sealant sublayer 216 adheres less strongly to the remainder of the multi-layer film 210 or alternatively outer sealant layer 217, than the bond formed between outer sealant layers 217 and 207. Therefore, when a peel force is applied to the sealed flange areas of the cover member and tray member, the seal ruptures along the inner base member sealant sublayer 216 such that the cover member and tray member become physically separable.

The difference in adhesion properties is provided in these sealant sublayers by selection of their respective formulations. For example, the outer sealant sublayer 217 and sealant layer 207 may be formulated to comprise approximately 100% neutralized ethylenic acid copolymer sealant materials, such as sodium or zinc ionomer sealant materials, that are not blended or essentially unblended with other types of sealant polymers. The base member sealant sublayer 216 may be formulated, for example, as generally comprised of a combination of polybutylene and either ethylene vinyl acetate copolymer (EVA), linear low density polyethylene (LLDPE), neutralized ethylene acid copolymer or unneutralized ethylene acid copolymer. For instance, the sealant sublayer 216 may be formulated as a blend of polybutylene and EVA, or polybutylene and LLDPE. The polymer blend proportions for the base member sealant sublayer 216 may vary, but generally may include about 5 wt. % to about 30 wt. % polybutylene, and about 95 wt. % to about 70 wt. % of the different sealing polymer material such as EVA and or LLDPE. For example, in one embodiment, base member sealant sublayer 216 may comprise about 86-90 wt. % LLDPE or EVA, and about 14 to about 10 wt. % polybutylene.

The rupture force needed to separate (peel) the sealant sublayers apart, as provided on the food side of either the cover member or tray member, should not cause tears nor delamination elsewhere in the container components; nor should it leave a jagged or very rough surface behind on the flanges where rupture is provided; nor should it deform the integral projections and recesses provided on either of the respective cover member and tray member flanges that are used for mechanical snap-fits permitting reclosure of the container components after they are unsealed from each other for the first time.

In addition to the above and subject to any requirements indicated herein, one or more layers of the sealant and or barrier films of the multi-layer films may also include one or more additives useful in packaging films, such as, antiblocking agents, slip agents, flavorants, antimicrobial agents, meat preservatives, antioxidants, fillers, radiation stabilizers, and antistatic agents, and so forth. Such additives, and their effective amounts, are generally known in the art.

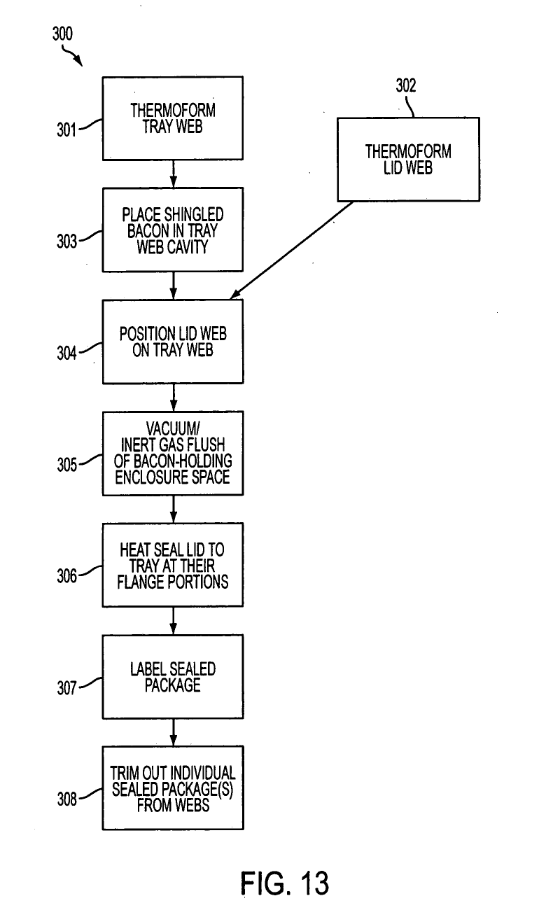

Referring to FIG. 13, in one embodiment, the tray member and the cover member are formed, filled, and sealed as a continuous in-line procedure 300. A roll stock of a multi-layer web, such as described herein, may be used as the supply web for each container component. Separate webs may be conveniently processed on continuous and intermittent motion vacuum thermoforming machines, or comparable in-line forming equipment, to form the tray member and the cover member. For example, the tray member and the cover member may be separately manufactured from a suitable separate web that is shaped by thermoforming or other suitable plastic web shaping technique known in the art. Suitable thermoforming methods, for example, include a vacuum forming or plug-assist vacuum forming method.

In a vacuum forming method, a web is heated, e.g., by a contact heater and a vacuum is applied beneath the web causing the web to be drawn or pushed by atmospheric pressure down into a preformed mold. In a plug-assist vacuum forming method, after the first or forming web has been heated and sealed across a mold cavity, a plug shape similar to the mold shape impinges on the opposite side of the forming web and, upon the application of vacuum, the forming web transfers to the mold surface. A web thermoformed into the tray member may be deep drawn in this manner to form a receptacle having the base surface contour described herein for receiving shingled bacon (301). A separate web is thermoformed into the cover member (302). The respective webs may have the above-noted multi-layer film constructions.

The forming web which is shaped into the tray member structure is positioned in a manner suitable to receive a predetermined amount of shingled bacon, which is placed therein by manual or automated loading (303). A second separately thermoformed web corresponding to the cover member may be thermoformed into the appropriate shape with a similar method. The stiffness of the cover member may optionally be enhanced by embossing patterns into it, such as a rhomboid pattern.

The cover member web is positioned over the tray member web (304). The tray member, as filled with bacon, is then attached to the cover member, which has been separately formed, at their respective contacting peripheral flanges. For example, the cover member peripheral flange is contacted with the tray member peripheral flange in a contiguous manner. The cavity containing the bacon which is enclosed within the two superposed webs has a vacuum pulled on it and then it is flushed with an inert gas (step 305). Alternatively, this vacuum/flush procedure alternatively may be repeated one or more times, or only vacuum or inert gas flushing may be used alone. Another alternative method may be the use of an oxygen scavenger by itself or in combination with one of the previously mentioned methods.

The cover member and tray member preferably are then heat sealed at their aligned and contacting peripheral flanges (306) in a manner that may be manually peeled apart by a consumer. The resulting heat seal preferably extends continuously around the flanges to hermetically seal or enclose the shingled bacon within the package. In this manner, the cover member and tray member form a substantially gas- and debris-impermeable enclosure for the shingled bacon. The resulting heat seal bond made between the cover member and tray member is sufficiently strong to withstand the expected handling and use conditions of the container.

The cover member and tray member flanges preferably are fusion sealed together in a peelably adhered manner. Fusion sealing may be done with a heat-sealing device which may be brought into contact with the cover member and tray member flanges. The seal may be formed using heated jaws, heat-sealing bars, platens, or frames, which apply heat pressure to the top and bottom webs in the seal area. In particular, the transmission of heat to the sealant layers on the contacting peripheral flanges of the two container parts induces a tacky state in the sealant layers such that they intermix and join or weld together upon being cooled. Sealing may be obtained between the cover member and tray member flanges by a variety of different methods including, for example, use of thermal conductance, dielectric sealing, ultrasonic sealing, radio frequency sealing, laser sealing, or other energy sources which may cause the sealant materials to bond, fuse or otherwise seal.

The sealed packages may be labeled (step 307), such as using conventional pressure sensitive food package labeling. In this embodiment, the individual sealed packages are then trimmed out of the superposed tray and lid webs (step 308), and may be packaged, shipped, and or shelved in any convenient manner.

The inter-laminar bond strength of the layers making up each forming web should be greater than the adhesive strength of the sealant layers of the first and second webs. Therefore, the cover member and tray member may be relatively cleanly peeled apart at the sealant layers at their respective flanges without leaving a jagged or rough separation surface on the flanges and without tearing or permanently deforming other structural features of the components, especially the snap-fittable projections and recesses. The snap fit projections are used to mechanically reclose the container after it has been unsealed and opened at the flanges.

While the invention has been particularly described with specific reference to particular process and product embodiments, it will be appreciated that various alterations, modifications and adaptations may be based on the present disclosure, and are intended to be within the spirit and scope of the present invention as defined by the following claims.

1. A reclosable package containing sliced bacon, comprising:
a generally rigid tray member having a tray base, generally upstanding tray sidewalls, and generally upstanding tray endwalls, and a tray member peripheral flange which surrounds an open mouth generally opposite the tray base, wherein the tray base comprises a generally flat central base portion disposed between two inclined base portions which merge with the generally upstanding tray sidewalls at respective locations below the tray member peripheral flange, and a peripheral ledge portion extends along inner surface of the sidewalls and endwalls adjacent the mouth of the tray member; and
a shingled stack of sliced bacon disposed within the tray member;
a generally rigid cover member securable onto the tray member, the cover member including a cover panel, a cover member peripheral flange, and a peripheral inset portion joining and spacing the cover panel and the cover member peripheral flange;
wherein:
the cover member peripheral inset portion slidably engages the tray member peripheral ledge portion, wherein the cover panel and tray base define an interior volume for enclosing the stack of shingled bacon supported on the tray base when the cover member peripheral flange is seated on the tray member peripheral flange,
the cover member peripheral inset portion includes a plurality of projections or indentations releasably engageable with indentations or projections on the tray member peripheral ledge portion, and
at least one of the cover member and tray member having transparency to permit visible inspection therethrough of the sliced bacon enclosed within the package.

2. The reclosable package of claim 1, wherein the package has transparency to permit visible inspection therethrough of at least about 70% of a sliced bacon strip within the package.

3. The reclosable package of claim 1, wherein the tray member comprises transparent plastic.

4. The reclosable package of claim 1, wherein the tray member comprises opaque plastic.

5. The reclosable package of claim 1, wherein the tray member and cover member both comprise transparent plastic.

6. The reclosable package of claim 1, wherein the cover member peripheral inset portion includes a plurality of ribs releasably engageable with grooves on the tray member peripheral ledge portion.

7. The reclosable package of claim 1, wherein the cover member peripheral inset portion includes a plurality of ribs which are releasably engageable with a plurality of respective grooves located on the tray member peripheral ledge portion along opposite endwalls and opposite sidewalls of the tray member.

8. The reclosable package of claim 1, wherein the cover member peripheral inset portion includes a plurality of ribs which are releasably engageable with a plurality of respective grooves located on the tray member peripheral ledge portion along either opposite endwalls or opposite sidewalls of the tray member.

9. The reclosable package of claim 1, wherein the cover member peripheral inset portion includes a plurality of ribs which are releasably engageable with a plurality of respective grooves located on the tray member peripheral ledge portion at corners of the tray member.

10. The reclosable package of claim 1, wherein the inclined base portions individually have respective inclination angles in the range from about 20 to about 40 degrees.

11. The reclosable package of claim 10, wherein the inclination angle of one the inclined base portions is about 3 to about 10 degrees less than the inclination angle of the other inclined base portion, wherein a shingled bacon slice located above the base portion having the lesser inclination angle has increased surface area visible compared to a shingled bacon slice located above the other inclined base portion.

12. The reclosable package of claim 11, wherein the inclined base portions individually have widths of about 50 to about 80% the width of the central base portion.

13. The reclosable package of claim 1, wherein the tray member and cover member are heat-sealed together between the cover member peripheral flange and the tray member peripheral flange.

14. The reclosable package of claim 1, wherein the cover member and tray member independently comprise a moldable or thermoformable construction material selected from the group consisting of homogenous plastic film, heat sealable-coated plastic film, multi-layered film laminates, and co-extruded films, or combinations thereof.

15. The reclosable package of claim 1, wherein the cover member comprises a thermoformed transparent multi-layered plastic film construction including at least (a) a thin, intermediate layer which is substantially impervious to oxygen, in combination with (b) an outer structural layer having sufficient structural characteristics so that the plastic film is sufficiently rigid for shape retention during handling, and usage of the integral snap-fit closure features included with the package, and (c) a sealant layer suitable for heat sealing procedures.

16. The reclosable package of claim 1, wherein the tray member comprises a thermoformed multi-layered plastic film construction including at least (a) a thin, intermediate layer which is substantially impervious to oxygen, in combination with (b) an outer structural layer having sufficient structural characteristics so that the plastic film is sufficiently rigid for shape retention during handling, and usage of the integral snap-fit closure features included with the package, and (c) a sealant layer suitable for heat sealing procedures.

17. The reclosable package of claim 16, wherein the outer structural layer comprises a colored or opaque plastic material.

18. The reclosable package of claim 16, wherein the sealant layer comprises a multi-film sealant construction having a rupturable interface.

19. A reclosable package for foodstuffs, comprising:
a generally rigid tray member having a tray base, generally upstanding tray sidewalls, and generally upstanding tray endwalls, and a tray member peripheral flange which surrounds an open mouth generally opposite the tray base, wherein the tray base comprises a generally flat central base portion disposed between two inclined base portions which merge with the generally upstanding tray sidewalls at respective locations below the tray member peripheral flange, and a peripheral ledge portion extends along inner surface of the sidewalls and endwalls adjacent the mouth of the tray member; and
a generally rigid cover member securable onto the tray member, the cover member including a cover panel, a cover member peripheral flange, and a peripheral inset portion joining and spacing the cover panel and the cover member peripheral flange;
wherein:
the cover member peripheral inset portion slidably engages the tray member peripheral ledge portion, wherein the cover panel and tray base define an interior volume sufficient for enclosing a foodstuff supported on the tray base when the cover member peripheral flange is seated on the tray member peripheral flange,
the cover member peripheral inset portion includes a plurality of projections or indentations releasably engageable with indentations or projections on the tray member peripheral ledge portion, and
at least one of the cover member and tray member having transparency to permit visible inspection therethrough of the sliced bacon enclosed within the package.

20. A method for packing shingled bacon slices using a reclosable package, comprising:
providing packaging components including:
a generally rigid tray member having a tray base, generally upstanding tray sidewalls, and generally upstanding tray endwalls, and a tray member peripheral flange which surrounds an open mouth generally opposite the tray base, wherein the tray base comprises a generally flat central base portion disposed between two inclined base portions which merge with the generally upstanding tray sidewalls at respective locations below the tray member peripheral flange, and a peripheral ledge portion extends along inner surface of the sidewalls and endwalls adjacent the mouth of the tray member;
a generally rigid cover member securable onto the tray member, the cover member including a cover panel, a cover member peripheral flange, and a peripheral inset portion joining and spacing the cover panel and the cover member peripheral flange;
wherein:
the cover member peripheral inset portion slidably engages the tray member peripheral ledge portion, wherein the cover panel and tray base define an interior volume for enclosing a stack of shingled bacon supported on the tray base when the cover member peripheral flange is seated on the tray member peripheral flange,
the cover member peripheral inset portion includes a plurality of projections or indentations releasably engageable with indentations or projections on the tray member peripheral ledge portion, and
at least one of the cover member and tray member having transparency to permit visible inspection therethrough of sliced bacon when enclosed within the package;
introducing shingled bacon slices into the rigid tray member as supported on the tray base;
optionally flushing the tray member and enclosed shingled bacon slices with inert gas; and,
covering the tray member with the cover member in a sealed manner.

21. The method of claim 20, wherein covering the tray member with the cover member in a sealed manner comprises:
seating the cover member peripheral flange on the tray member peripheral flange; and
heat-sealing the cover member peripheral flange to the tray member peripheral flange.

22. The method of claim 21, wherein the providing of the packaging components comprises separately thermoforming the tray member and the cover member.
